(19) United States
(12) Patent Application Publication
(10) Pub. No.: US 2024/0293995 A1
(43) Pub. Date: Sep. 5, 2024

(54) Method of Constructing Composite Stiffened Building Materials

(71) Applicant: Peter Sing, McCleary, WA (US)

(72) Inventor: Peter Sing, McCleary, WA (US)

(21) Appl. No.: 18/117,303

(22) Filed: Mar. 3, 2023

(51) Int. Cl. B32B 7/12; B32B 3/30; B32B 38/00

(52) U.S. Cl. CPC B32B 7/12; B32B 3/30; B32B 38/0004; B32B 2250/42; B32B 2305/30; B32B 2419/00

(57) ABSTRACT

This patent is a new method of constructing composite stiffened building materials. Conventional door construction materials are made of solid wood, MDF, or LVL. Solid wood tends to move over time and is very heavy. MDF and LVL core doors tend to be extremely heavy and both have a tendency to delaminate or move over time, especially when exposed to moisture. This new method of building stile and rail doors will create lasting stile and rail doors of any size last without warping and remaining high strength, lightweight, and rigid. The stiles, or horizontal members, and rails, or vertical members, can be made of honeycomb core, laminated alternating wood products and stiffening materials like the Composite Stiffener, U.S. Patent No. 63/313,649.

The composite stiffener comprises of multiple layers (at least 2) of aluminum, formica, plastic, sheet metals, fiberglass, or other strengthening materials: plywood, vencer, multiple layers of veneer, MDF, or other wood products for adequate bonding surface; and honeycomb core, paper core, hollow core, or other filler materials. The materials listed above can alternate and be adhered with an adhesive. Once the adhesive is fully cured, the layers of materials can be cut length-wise or width-wise perpendicular to the width edge of the sandwiched materials. Thickness of the section being cut is determined by the thickness of the core used in the panel the composite stiffener is intended for. The section that was previously cut off, is the composite stiffener, to be placed with the end grain to each surface of the panel requiring the stiffener. With the end grain of the stiffener facing the inner surface of the panel, or the stiffener layers are perpendicular to the surface of the panel, ensures the panel containing the stiffener will remain straight and not warp, bend, twist, or otherwise fail.

The composite stiffener material can have lumber adhered to at least two sides with any adhesive. Skin material can be adhered to the top and bottom faces of the composite stiffener core material. Skin material can be flat building materials such as plywood, vencer, multiple layer vencer, MDF, HPL, formica, plastics, aluminum, metals, fiberglass, or other flat building materials. This creates the composite stiffened building materials like stiles and rails material. They can be profiled to fit together with the desired amount of panels.

### BACKGROUND OF INVENTION

This patent is a new method of constructing composite stiffened building materials. Conventional stile and rail style doors are made of solid wood. MDF, or LVL. Solid wood tends to move over time and is very heavy. MDF and LVL core doors tend to be extremely heavy and both have a tendency to delaminate or move over time, especially when exposed to moisture. This new method of building stile and rail doors will create lasting stile and rail doors of any size last without warping and remaining high strength, lightweight, and rigid. The stiles, or horizontal members, and rails, or vertical members, can be made of honeycomb core, laminated alternating wood products and stiffening materials like the Composite Stiffener. U.S. Patent No. 63/313.649.

The composite stiffener comprises of multiple layers (at least 2) of aluminum, formica, plastic, sheet metals, fiberglass, or other strengthening materials: plywood, veneer, multiple layers of veneer. MDF, or other wood products for adequate bonding surface; and honeycomb core, paper core, hollow core, or other filler materials. The materials listed above can alternate and be adhered with an adhesive. Once the adhesive is fully cured, the layers of materials can be cut length-wise or width-wise perpendicular to the width edge of the sandwiched materials. Thickness of the section being cut is determined by the thickness of the core used in the panel the composite stiffener is intended for. The section that was previously cut off, is the composite stiffener, to be placed with the end grain to each surface of the panel requiring the stiffener. With the end grain of the stiffener facing the inner surface of the panel, or the stiffener layers are perpendicular to the surface of the panel, ensures the panel containing the stiffener will remain straight and not warp, bend, twist, or otherwise fail.

The composite stiffener material can have lumber adhered to at least two sides with any adhesive. Skin material can be adhered to the top and bottom faces of the composite stiffener core material. Skin material can be flat building materials such as plywood, veneer, multiple layer veneer. MDF. HPL, formica, plastics, aluminum, metals, fiberglass, or other flat building materials. This creates the composite stiles and rails material. They can be profiled to fit together with the desired amount of panels.

The stiles and rails can be joined with an adhesive and/or mechanical fasteners, dowels, biscuits, splines adhered across the joins. Conventionally, laminated stile and rail members are comprised of a core material that is cut to size and then lumber or similar materials are clamped and adhered to the edges of the member. The lumber or similar product allows for the edges to be profiled. Profiled members can be used for stile and rail doors, moulding, and trim. The skin materials are then pressed to the surfaces of the core material. The new method of creating composite stiffened building materials provides a simpler method and simplified manufacturing process.

This composite lumber can replace dimensional lumber in any of its various applications. The composite lumber can greatly increase the strength achieved by conventional lumber. This can be used as any dimensional lumber like 2×2's. 2×4's. 2×6's. 4×4's, or any other dimensional lumber. The lumber pressed between the stiffening material can be any thickness and could have relief kerfs cut into either side deemed necessary: The relief cuts in combination with the stiffening material will counteract the lumber's tendency to move over time and will remain dimensionally stable for a lifetime. Relief cuts should be incrementally placed and staggering other cuts if being layered on top of each other. If the relief cuts were on top of each other, this would create a weak point with a high potential for failure.

The composite stiffened building materials can provide extremely high strength with less surface area. This means that the frames, if being used for doors or windows, can be much narrower or smaller than conventional materials providing a more streamlined appearance and lighter weight. For use in stile and rail frames, the stile members and rail members can be narrower than the conventional building materials. The composite lumber can be used for door frames, window frames, other types of framing, posts, beams, studs, or any other type of lumber building materials. Skin material can be wrapped around all sides of the composite member to increase the shear strength and prevent any buckling.

### SUMMARY OF INVENTION

This patent is a new method of constructing composite stiffened building materials. Conventional doors are made of solid wood. MDF, or LVL. Solid wood tends to move over time and is very heavy. MDF and LVL core doors tend to be extremely heavy and both have a tendency to delaminate or move over time, especially when exposed to moisture. This new method of building stile and rail doors will create lasting stile and rail doors of any size last without warping and remaining high strength, lightweight, and rigid. The stiles, or horizontal members, and rails, or vertical members, can be made of honeycomb core, laminated alternating wood products and stiffening materials like the Composite Stiffener. U.S. Patent No. 63/313.649.

The composite stiffener comprises of multiple layers (at least 2) of aluminum, formica, plastic, sheet metals, fiberglass, or other strengthening materials: plywood, vencer, multiple layers of veneer, MDF, or other wood products for adequate bonding surface; and honeycomb core, paper core, hollow core, or other filler materials. The materials listed above can alternate and be adhered with an adhesive. Once the adhesive is fully cured, the layers of materials can be cut length-wise or width-wise perpendicular to the width edge of the sandwiched materials. Thickness of the section being cut is determined by the thickness of the core used in the panel the composite stiffener is intended for. The section that was previously cut off, is the composite stiffener, to be placed with the end grain to each surface of the panel requiring the stiffener. With the end grain of the stiffener facing the inner surface of the panel, or the stiffener layers are perpendicular to the surface of the panel, ensures the panel containing the stiffener will remain straight and not warp, bend, twist, or otherwise fail.

The composite stiffener material can have lumber adhered to at least two sides with any adhesive. Skin material can be adhered to the top and bottom faces of the composite stiffener core material. Skin material can be flat building materials such as plywood, veneer, multiple layer veneer. MDF. HPL, formica, plastics, aluminum, metals, fiberglass, or other flat building materials. This creates the composite stiles and rails material. They can be profiled to fit together with the desired amount of panels.

The stiles and rails can be joined with an adhesive and/or mechanical fasteners, dowels, biscuits, splines adhered across the joins.

This composite lumber can replace dimensional lumber in any of its various applications. The composite lumber can greatly increase the strength achieved by conventional lumber. This can be used as any dimensional lumber like 2×2's. 2×4 s. 2×6′s. 4×4′s, or any other dimensional lumber. The lumber pressed between the stiffening material can be any thickness and could have relief kerfs cut into either side deemed necessary: The relief cuts in combination with the stiffening material will counteract the lumber's tendency to move over time and will remain dimensionally stable for a lifetime. Relief cuts should be incrementally placed and staggering other cuts if being layered on top of each other. If the relief cuts were on top of each other, this would create a weak point with a high potential for failure.

The composite stiffened building materials can provide extremely high strength with less surface area. This means that the frames, if being used for doors or windows, can be much narrower or smaller than conventional materials providing a more streamlined appearance and lighter weight. For use in stile and rail frames, the stile members and rail members can be narrower than the conventional building materials. The composite lumber can be used for door frames, window frames, other types of framing, posts, beams, studs, or any other type of lumber building materials.

The stiffening material does not need to be perpendicular to the skin materials, it can be parallel to the skin material if necessary. The skin material can be one single sheet across the whole core material. The skin can also be multiple sections laid flush together to cover the core material. The Skin can be made of pre-joined materials like joined veneer or plywood, or the skin can be many pieces of flat sheet goods like wood staves.

### SHORT FIGURE DESCRIPTION OF DRAWINGS

FIG. 1 is a birds eye view of the alternating lumber and stiffening material adhered together.

FIG. 2 is a birds eye view of a slice of alternating lumber and stiffening material rotated on its side.

FIG. 3 is a birds eye view of the slice of alternating lumber and stiffening material being placed between two layers of skin material.

FIG. 4 is a birds eye view of the slice of alternating lumber and stiffening material pressed between two layers of skin.

FIG. 5 is a birds eye view of the block of lumber and stiffening material with intermittent larger sections of lumber.

FIG. 6 is a birds eye view of a slice of the alternating larger lumber and stiffening material.

FIG. 7 is a birds eye view of the slice off the alternating lumber and stiffening material being placed between two layers of skin materials.

FIG. 8 is a birds eye view of the slice pressed between two layers of skin material, depicting where the panel will be cut.

FIG. 9 is a birds eye view of the slice pressed between two layers of skin material after being cut in the center.

FIG. 10 is a birds eye view of one of the cut off members from the alternating lumber and stiffening materials.

FIG. 11 is a view of the cut off member after having the edges profiled.

FIG. 12 is a front view of the conventional method of profiling composite lumber.

### DESCRIPTION OF THE PREFERRED EMBODIMENTS

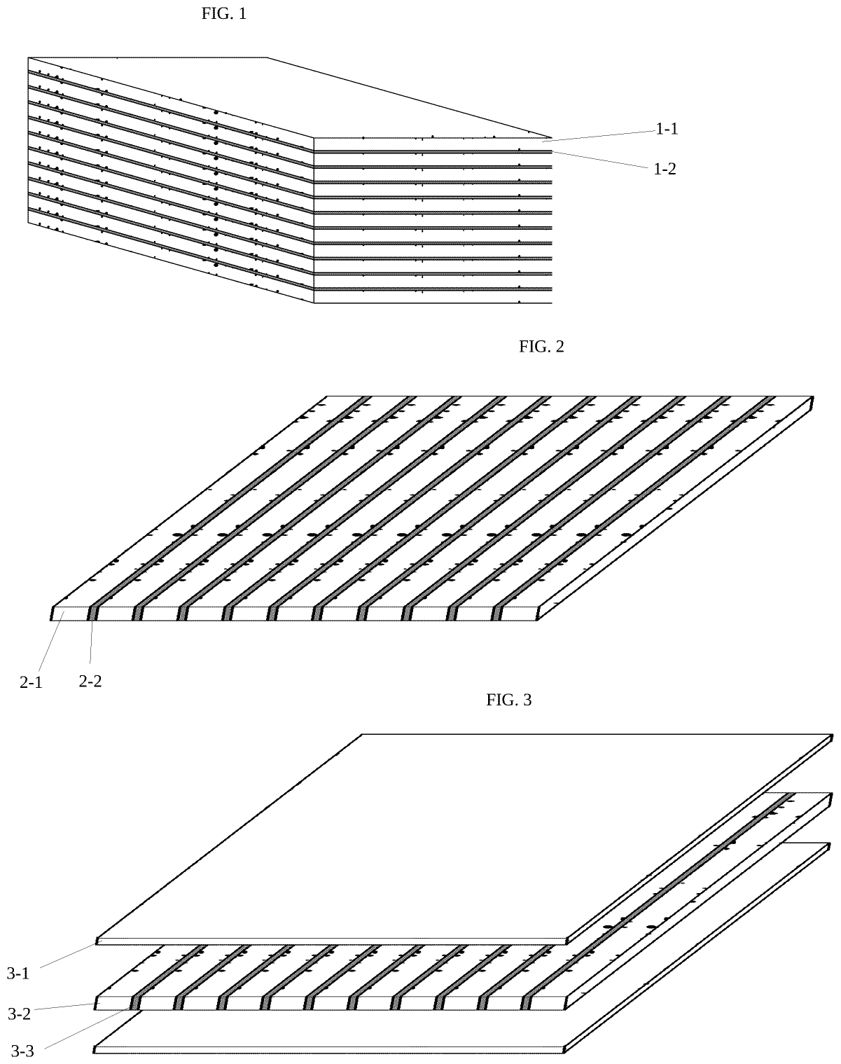

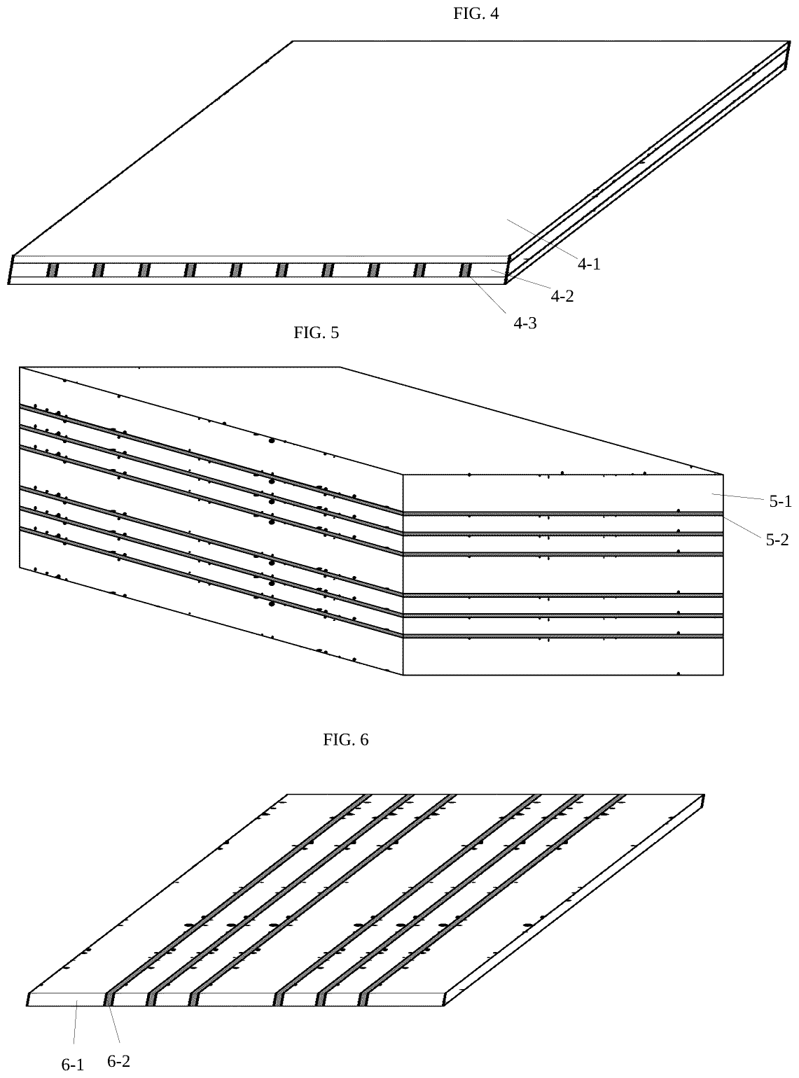

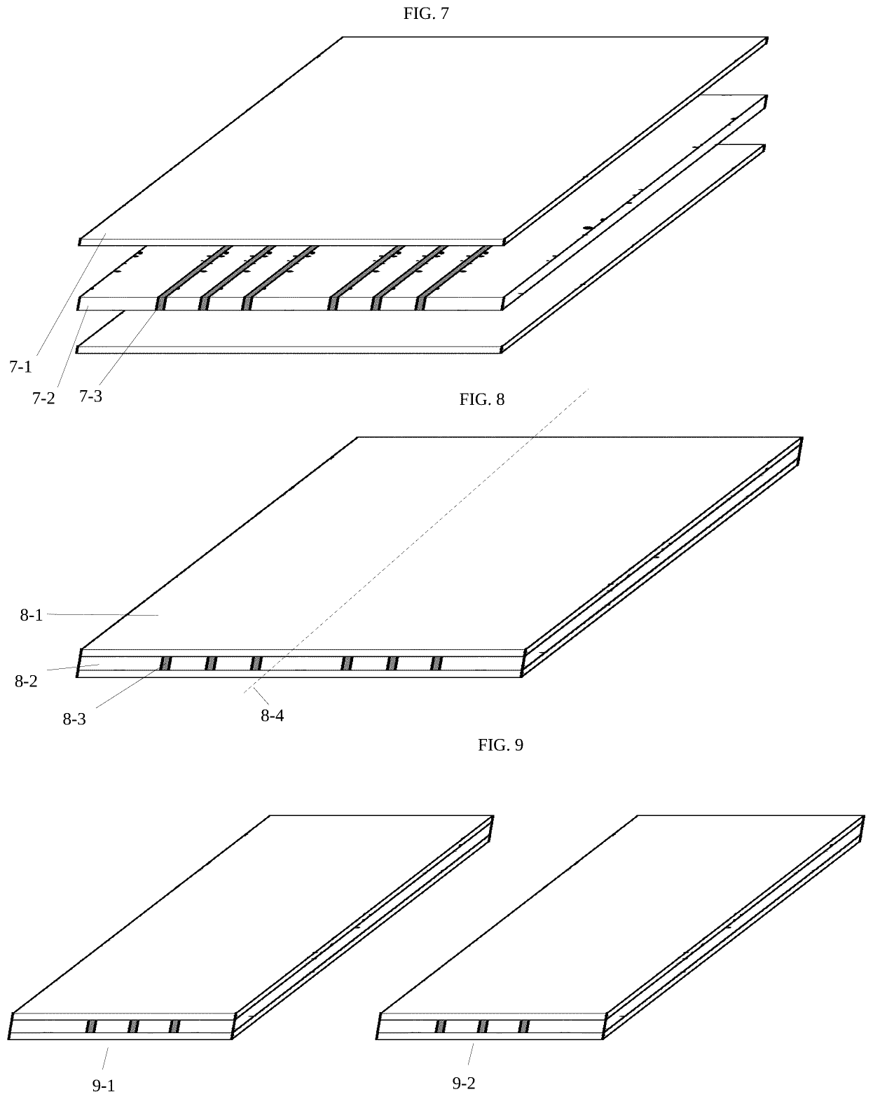

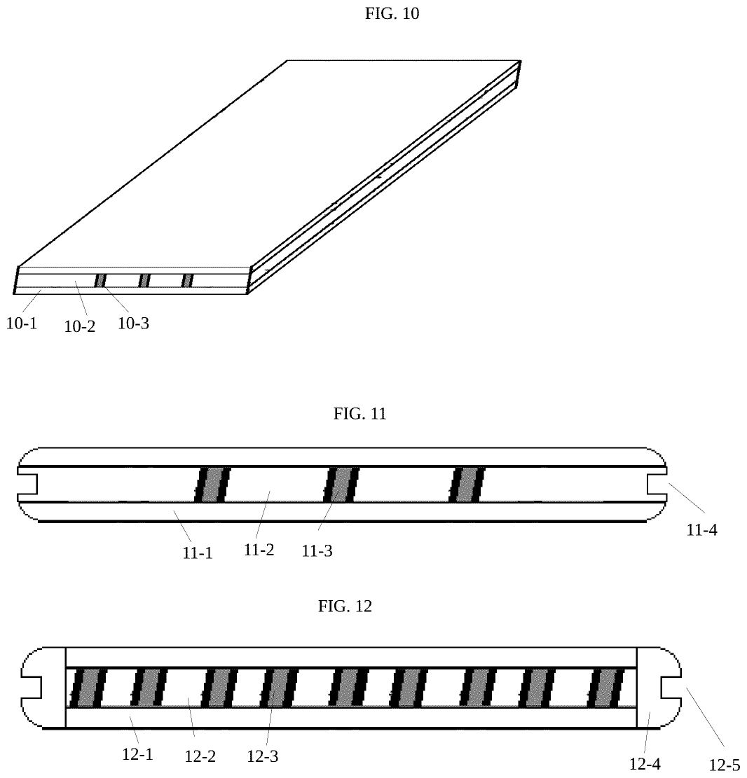

The composite stiffened building material is comprised of at least two layers of aluminum, formica, plastic, sheet metals, fiberglass, or other strengthening materials: plywood, vencer, multiple layers of vencer, MDF, or other wood products for adequate bonding surface; and honeycomb core, paper core, hollow core, or other filler materials. The alternating layers of lumber 1-1 and stiffening material 1-2 can be adhered together to form a block FIG. 1. Once the adhesive is fully cured, the block can be sliced perpendicular through the alternating layers of lumber 2-1 and stiffening material 2-2 FIG. 2. The slice from the initial block containing the alternating layers of lumber 3-2 and stiffening material 3-3 can be placed between two layers of skin material 3-1 FIG. 3. The skins 4-1 can be adhered to the slice of alternating lumber 4-2 and stiffening material 4-3. Alternatively, the block of alternating lumber 5-1 and stiffening material 5-2 can contain larger pieces of lumber to later be cut in half FIG. 5. Similarly, the block can be sliced perpendicular to the alternating layers of lumber 6-1 and stiffening material 6-2 FIG. 6. The resulting slice of alternating lumber 7-2 and stiffening material 7-3 can have skin material 7-1 placed on either side FIG. 7. The skin 8-1 can then be adhered to the slice of alternating lumber 8-2 and stiffening material 8-3 with the larger lumber in the center to be cut to create separate members 8-4 FIG. 8. The panel can be cut down the larger piece of lumber 8-4, creating two separate members 9-1, 9-2 FIG. 9. The resulting member is comprised of skin materials 10-1, lumber 10-2, and stiffening materials 10-3 FIG. 10. The resulting member is ready for use, it can be covered on all sides or the sides with lumber 11-2 can be profiled 11-4 and remain structurally sound with the stiffening material 11-3 and shear strength from the skin material 11-1 FIG. 11. Conventionally, to obtain profiled edges with a composite member, comprised of a stiffening material 12-3 and a filler material 12-2 contained by skin material 12-1, lumber must be fastened or adhered to the edges 12-4 to be profiled 12-5 FIG. 12.

What is claimed is:

1. The composite stiffened building materials comprises of multiple layers (at least 2) of aluminum, formica, plastic, sheet metals, fiberglass, or other strengthening materials: plywood, veneer, multiple layers of veneer, MDF, or other wood products for adequate bonding surface; and honeycomb core, paper core, hollow core, or other filler materials. The materials listed above can alternate and be adhered with an adhesive. Once the adhesive is fully cured, the layers of materials can be cut length-wise or width-wise perpendicular to the width edge of the sandwiched materials. Thickness of the section being cut is determined by the thickness of the core used in the panel the composite stiffener is intended for. The section that was previously cut off, is the composite stiffener, to be placed with the end grain to each surface of the panel requiring the stiffener. With the end grain of the stiffener facing the inner surface of the panel, or the stiffener layers are perpendicular to the surface of the panel, ensures the panel containing the stiffener will remain straight and not warp, bend, twist, or otherwise fail.

2. In accordance of claim 1, the composite stiffened building materials can be used in a wide variety of applications as conventional lumber can be used. This can replace conventional lumber products such as dimensional lumber, studs, posts, beams, door frames, window frames, or any other building materials.

3. In accordance with claim 1, the composite building material can be sandwiched between at least two pieces of lumber, metal, plastic, fiberglass, HPL, MDF, or other flat sheet goods. The top and bottom surfaces can have a skin material adhered. Skin material can be any flat sheet building materials. The skin applied will greatly increase the shear strength of the composite stiffened building materials.

4. In accordance with claim 1, the composite stiffened building material can be profiled with any shape, like tongue and groove, to be made into stile and rail doors, doors with glass inserts, doors with raised panels, door frames, window frames, and many more applications.
